(19) United States
(12) Patent Application Publication
(10) Pub. No.: US 2009/0233793 A1
(43) Pub. Date: Sep. 17, 2009

(54) METHOD OF PREPARATION OF SPHERICAL SUPPORT FOR OLEFIN POLYMERIZATION CATALYST

(75) Inventors: Joon-Ryeo Park, Daejeon (KR); Ho-Sik Chang, Daejeon (KR); Jin-Kyu Ahn, Seoul (KR)

Correspondence Address: BARLOW, JOSEPHS & HOLMES, LTD., 101 DYER STREET, 5TH FLOOR, PROVIDENCE, RI, 02903, US

(73) Assignee: SAMSUNG TOTAL PETROCHEMICALS CO., LTD., Chungcheongnam (KR)

(21) Appl. No.: 11/575,678

(22) PCT Filed: Mar. 31, 2005
(86) PCT No.: PCT/KR05/00942

§ 371 Date: May 19, 2009

(30) Foreign Application Priority Data
Sep. 23, 2004 (KR) 10-2004-0076249

(51) Int. Cl. B01J 21/10

(52) U.S. Cl. 502/439

(57) ABSTRACT

Disclosed is a method of preparation of spherical support for olefin polymerization catalyst, wherein the support is produced by continuously introducing a mixture of metal magnesium and alcohol into a reactor containing a mixture comprising halogen compound and alcohol and optionally dialkoxymagnesium, and then the magnesium is reacted with the alcohol in the presence of the mixture comprising halogen compound and alcohol and optionally dialkoxy-magnesium. By the method, it is possible to control the reaction rate appropriately and to improve particle shape and particle size distribution of the resulted dialkoxymagnesium support.

### TECHNICAL FIELD

The present invention relates to a method of preparation of spherical support for olefin polymerization catalyst, wherein the support is produced by continuously introducing a mixture of metal magnesium and alcohol into a reactor containing a mixture comprising halogen compound and alcohol and optionally dialkoxy-magnesium, and then the magnesium is reacted with the alcohol in the presence of the mixture comprising halogen compound and alcohol and optionally dialkoxy-magnesium. By the method, it is possible to control the reaction rate appropriately and to improve particle shape and particle size distribution of the resulted dialkoxy-magnesium support.

### BACKGROUND ART

As an olefin polymerization catalyst, Ziegler-Natta catalysts supported by magnesium chloride are most widely used at present. The Ziegler-natta catalyst supported by magnesium chloride is a solid catalyst component generally comprised of magnesium, titanium, halogen and electron-donating organic compounds. When used in polymerization of alpha-olefins such as propylene, it may be mixed with an organ aluminum compound as a cocatalyst and an organosilane compound as a stereo-regularity modifying agent in appropriate mixing ratios, and introduced into a polymerization reactor. Since spherical supports for olefin polymerization catalyst are applied to various commercial processes such as slurry polymerization, bulk polymerization, gas-phase polymerization and the like, it is necessary to satisfy various properties related with particle morphology, i.e. appropriate particle size and shape, uniform particle distribution, minimization of fine particles, high bulk density and the like, as well as high catalyst activity and stereoregularity which are basically required.

### DISCLOSURE OF INVENTION

### Technical Problem

For improving the particle morphology in a support for olefin polymerization catalyst, there have been many methods well known in this field such as recrystallization, reprecipitation, spray-drying, methods using chemical reactions and the like. As one of the methods using chemical reactions, a method for preparing a catalyst using a dialkoxymagnesium obtained by reacting magnesium with an alcohol as a support has been drawing increasing attentions in recent years, since this method can provide a catalyst having very high activity and polymers having high stereoregularity, as compared with other catalyst preparation methods. However, in case of using dialkoxymagnesium as a support, the dialkoxymagnesium support should be prepared as being highly uniform and spherical, as well as having sufficiently high bulk density, through the reaction between magnesium and an alcohol, since the particle characteristics of the resulted catalyst and polymers are directly affected by the particle shape, particle size distribution, bulk density and the like of the dialkoxymagnesium used as a support.

With respect to this, there have been various methods to prepare dialkoxy-magnesium having a uniform shape, disclosed in conventional technical literatures. U.S. Pat. Nos. 5,162,277 and 5,955,396 suggest a method for preparing a support having a size of 5-10□, by recrystallizing magnesium ethylcarbonate, which is obtained from the carboxylation of amorphous diethoxymagnesium with carbon dioxide, in a solution containing various additives and solvents. Additionally, Japanese laid-open patent publication No. H06-87773 discloses a method for preparing spherical particles comprising spray-drying an alcoholic solution of a diethoxymagnesium which is carboxylated by carbon dioxide, and carrying out decarboxylation thereof. However, these conventional methods involves complex processes using many species of raw materials, and does not provide sufficiently good particle size and particle shape of a support.

Japanese laid-open patent publication Nos. H03-74341, H04-368391 and H08-73388 provide a method for synthesizing spherical or elliptical diethoxy-magnesium by reacting metal magnesium with ethanol in the presence of iodine. However, the diethoxymagnesium prepared by this method has problems in that the reaction is very rapidly occurred together with the generation of a great amount of reaction heat and hydrogen, thereby being difficult to control the reaction rate to desired level, and the resulted dialkoxymagnesium support contains a large amount of fine particles or large hetero-type particles formed by aggregation of several particles.

To summarize the above, in case of preparing dialkoxymagnesium by reacting metal magnesium with alcohol according to the conventional methods, non-spherical large particles having a size of 100□ or more are produced in a great amount owing to aggregation of the particles in the initial step of the reaction between metal magnesium and alcohol, therefore when a catalyst prepared from the resulted support directly is used in olefin polymerization, it will cause problems that the particle size of the resulted polymers becomes too big, or owing to polymerization heat, the particle morphology becomes disrupted, which in turn causes serious problems in the process, and the like.

### Technical Solution

The present invention is to solve those above-mentioned problems of the prior arts. Therefore, the present invention is to provide a method of preparation of spherical support for olefin polymerization catalyst which has uniform spherical particle shape and uniform particle size distribution, and hardly contains hetero-shaped large particles so that it is suitably used for producing a catalyst which satisfies various particle characteristics required in commercial olefin polymerization processes including slurry polymerization, bulk polymerization, gas-phase polymerization and the like.

### Mode for the Invention

According to the present invention, provided is a method of preparation of spherical support for olefin polymerization catalyst, wherein a mixture of metal magnesium and alcohol is continuously introduced into a reactor containing a mixture comprising halogen compound and alcohol, and then the magnesium is reacted with the alcohol in the presence of the mixture comprising halogen compound and alcohol to produce dialkoxymagnesium support.

Also, in the method of the present invention, the mixture comprising halogen compound and alcohol can further comprise dialkoxymagnesium.

The halogen compound useful in the present invention is preferably, for example, halogen molecule such as I₂, Br₂, IBr and the like; alkyl halide compound such as CH₃ I, CH₃Br, CH₃CH₂Br, BrCH₂CH₂Br and the like; acyl halide compound such as CH COCl, PhCOCl, Ph(COCl)₂ and the like; aluminum halide compound represented by the general formula AlClₘ(OR)₃₋ₘ, wherein R is hydrocarbon group having 1-10 carbon atoms, and m is a natural number of 1 to 3; silicon halide compound represented by the general formula SiClₙ(OR)₄₋ₙ, wherein R is hydrocarbon group having 1-10 carbon atoms, and n is a natural number of 1 to 4; or metal halide compound such as LiCl, LiBr, CaCl₂, MgCl₂, MgBr₂, MgI₂ and the like, and more preferably, the halogen compound is halogen molecule, alkyl halide compound or metal halide compound.

The amount of the halogen compound according to the present invention is preferably 0.001-0.2 parts by weight per 1 part by weight of the metal magnesium. When the amount of the halogen compound is less than 0.001 parts by weight, the reaction rate becomes too slow. On the other hand, when the amount of the halogen compound is more than 0.2 parts by weight, the particle size of the resulted products becomes excessively big, or fine particles may be produced in great amount. The dialkoxymagnesium optionally present in the mixture comprising halogen compound and alcohol is not limited by particle size distribution and average particle size thereof, however, preferably, it has a form of spherical particle having 1.5 or less of particle size distribution and 10-100□ of average particle diameter. When using dialkoxymagnesium in a form of particle having particle size distribution and average particle diameter out of the preferred ranges, it would cause a problem in that the particle size distribution of the final products becomes rather broadened.

As for such dialkoxymagnesium, those prepared by the present invention, those prepared by the method according to the present invention in which dial koxy-magnesium is not present in the mixture comprising halogen compound and alcohol, those prepared by the method disclosed in Korean patent application No. 10-2003-0087194, or those prepared by other general methods may be used in the present invention.

The amount of the dialkoxymagnesium optionally present in the mixture comprising halogen compound and alcohol is preferably 0.05-0.5 parts by weight per 1 part by weight of the alcohol in the mixture comprising halogen compound and alcohol. When the amount of the dialkoxymagnesium is less than 0.05 parts by weight, the content of large particles in the final product, i.e. spherical support, may become increase. On the other hand, when the amount is more than 0.5 parts by weight, in the final product, the content of initially introduced dialkoxymagnesium becomes too excessive, which causes problems of decrease in the improvement of particle size distribution and decrease in productivity.

Metal magnesium used in the present invention is not strictly limited by its shape, however, it is preferred in the form of a powder having an average particle size of 10-300□ and more preferably in the form of a powder having an average particle size of 50-200□. When the average particle size of the metal magnesium is less than 10□, the particles of the resulted support become too small, and when it is more than 300□, the particles of the support become too big to form a uniform spherical shape.

As for the alcohol useful in the present invention, it is preferred to use one or more of alcohols selected from the group consisting of aliphatic alcohols, represented by the general formula of ROH wherein R is an alkyl group having 1-6 carbon atoms, such as methanol, ethanol, n-propanol, iso-propanol, n-butanol, iso-butanol, n-pentanol, iso-pentanol, neo-pentanol, cyclopentanol, cyclohexanol and the like, and aromatic alcohols such as phenol, being used alone or as a mixture. Further, it is more preferred to use one or more of alcohols selected from the group consisting of methanol, ethanol, propanol and butanol, being used alone or as a mixture, and most preferred to use ethanol.

The total amount of alcohol used in the present invention is preferably 5-50 parts by weight, and more preferably 7-20 parts by weight per 1 part by weight of metal magnesium. When the total amount of alcohol used is less than 5 parts by weight, the viscosity of slurry becomes rapidly increase, accordingly it becomes difficult to achieve uniform mixing. On the other hand, when the total amount of alcohol used is more than 50 parts by weight, the bulk density of the resulted support becomes rapidly decrease, or particle surface thereof becomes rough. The amount of the alcohol in the mixture comprising halogen compound and alcohol and optionally dialkoxy-magnesium is preferably 2-20 parts by weight per 100 parts by weight of the total amount of alcohol used in the present invention. When the amount of the alcohol in the mixture comprising halogen compound and alcohol and optionally dialkoxy-magnesium is less than 2 parts by weight, it is not possible to obtain uniform spherical support particles owing to poor mixing, and when it is more than 20 parts by weight, the bulk density of the resulted product becomes lowered.

In the method for preparing a support according to the present invention, the reaction between metal magnesium and alcohol in the presence of the mixture comprising halogen compound and alcohol and optionally dialkoxymagnesium is carried out preferably at the temperature of 60-110° C., and more preferably at the temperature of 70-90° C. The reaction may also be carried out at the boiling point of the alcohol used, under refluxing. When the reaction temperature is lower than 60° C., the reaction becomes too slow. On the other hand, when it is higher than 110° C., the reaction is so rapid that the amount of fine particles may be rapidly increased and aggregation of particles may be occurred, therefore it is not possible to obtain uniform spherical supports in desired size.

The present invention may be rather fully understood through the following examples and comparative examples, however those examples are presented only for illustrating the present invention, by no means limiting the scope of the present invention.

### EXAMPLES

### Example 1

A 5 L-volume reactor (reactor A) equipped with a stirrer, an oil heater and a reflux condenser was sufficiently purged with nitrogen, and then charged with 3.0 g of magnesium chloride and 200 ml of dry ethanol. Then, stirring was started at 200 rpm while raising the temperature to 78° C. so as to maintain the ethanol to be refluxed. To the reactor A, 120 g of metal magnesium (a commercial product having an average particle diameter of about 100□) suspended into 1.6 L of dry ethanol in other 2.5 L container equipped with a stirrer, was added over 2 hours at a constant rate by using a slurry pump, while keeping stirring the suspension so as to make the concentration of the suspension uniform. In about 5 minutes after adding the mixture of metal magnesium and ethanol to the reactor A, the reaction was started, generating hydrogen thereupon. Accordingly, the outlet of the reactor was maintained open so as to let the generated hydrogen released out of the reactor and to maintain the reactor pressure to atmospheric pressure. After completing the addition of the mixture of metal magnesium and ethanol, the temperature and the stirring speed of the reactor were still maintained at refluxing state for 2 hours (aging). After completing the aging step, the resulted product was washed three times with 2000 ml of n-hexane at 50? for each washing. The resulted product was dried under the nitrogen stream for 24 hours to obtain 561 g (97% yield) of diethoxymagnesium as a solid white powder having good flowability.

The particle shape of the resulted dried product was observed with an electron microscope, and the bulk density was measured. Further, the resulted dried product was suspended in n-hexane and the particle size in the suspended state was measured by using a laser particle size analyzer (Mastersizer X, manufactured by Malvern Instruments) according to light transmission method, thereby obtaining the cumulative distribution of the particles. From the resulted cumulative distribution, the average particle diameter and particle size distribution index of the particles and the content of large particles were determined by the following methods:

\textcircled{1} Average particle diameter(D₅₀): the particle size corresponding to 50% of the accumulated weight

\textcircled{2} Particle size distribution index (P): P=(D₉₀−D₁₀)/D₅₀ (wherein, D₉₀ is the particle size corresponding to 90% of the accumulated weight, D₁₀ is the particle size corresponding to 10% of the accumulated weight)

\textcircled{3} Content of large particles: % of the accumulated weight of the particles having 100□ or more of particle diameter

The results from said observation, measurement and determination were represented in Table 1 below.

### Example 2

The same method as in Example 1 was carried out except that 50 g of diethoxy-magnesium obtained from Example 1 was added to the reactor A together with 3.0 g of magnesium chloride and 200 ml of dry ethanol. As a result, obtained were 610 g (97.8% yield) of a white solid powder having very good flowability.

By the same method as in Example 1, the particle shape of the resulted product was observed; the bulk density was measured; and the average particle diameter and particle size distribution index of particles and the content of large particles were determined. The results from the observation, measurement and determination were represented in Table 1 below.

### Example 3

The same method as in Example 1 was carried out except that 25 g of diethoxy-magnesium obtained from Example 1 was added to the reactor A together with 3.0 g of magnesium chloride and 200 ml of dry ethanol. As a result, obtained were 588 g (99% yield) of a white solid powder having very good flowability.

By the same method as in Example 1, the particle shape of the resulted product was observed; the bulk density was measured; and the average particle size and particle distribution index of particles and the content of large particles were determined. The results from the observation, measurement and determination were represented in Table 1 below.

### Example 4

The same method as in Example 1 was carried out except that 10 g of diethoxy-magnesium obtained from Example 1 was added to the reactor A together with 3.0 g of magnesium chloride and 200 ml of dry ethanol. As a result, obtained was 563 g (97% yield) of a white solid powder having very good flowability.

By the same method as in Example 1, the particle shape of the resulted product was observed; the bulk density was measured; and the average particle diameter and particle size distribution index of particles and the content of large particles were determined. The results from the observation, measurement and determination were represented in Table 1 below.

### Example 5

The same method as in Example 2 was carried out except that 3.0 g of iodine were used instead of 3.0 g of magnesium chloride. As a result, obtained were 612 g (99% yield) of a white solid powder having very good flowability.

By the same method as in Example 1, the particle shape of the resulted product was observed; the bulk density was measured; and the average particle diameter and particle size distribution index of particles and the content of large particles were determined. The results from the observation, measurement and determination were represented in Table 1 below.

### Comparative Example 1

A 5 L-volume reactor equipped with a stirrer, an oil heater and a reflux condenser was sufficiently purged with nitrogen, then charged with 3 g of magnesium chloride and 1800 ml of dry ethanol, and the temperature of the reactor was elevated to 78° C., while operating the stirrer at 200 rpm, so as to maintain ethanol to be refluxed. Then, to the reactor where ethanol was being refluxed, 120 g of metal magnesium (a commercial product having an average particle diameter of 100□) were added in portions by 20 g for 6 times, with the time interval of 20 minutes. After adding all of the 120 g of metal magnesium, it was maintained for 2 hours at the same stirring speed under ethanol reflux condition (aging). After completing the aging step, the resulted product was washed three times with 2000 ml of n-hexane at 40° C. for each washing. The resulted product was dried under the nitrogen stream for 24 hours to obtain 565 g (99% yield) of a white solid powder.

By the same method as in Example 1, the particle shape of the resulted product was observed; the bulk density was measured; and the average particle diameter and particle size distribution index of particles and the content of large particles were determined. The results from the observation, measurement and determination were represented in Table 1 below.

### Comparative Example 2

A 5 L-volume reactor equipped with a stirrer, an oil heater and a reflux condenser was sufficiently purged with nitrogen, then charged with 3 g of magnesium chloride and 200 ml of dry ethanol, and the temperature of the reactor was elevated to 78° C., while operating the stirrer at 200 rpm, so as to maintain ethanol to be refluxed. Then, to the reactor, 120 g of metal magnesium (a commercial product in a powder form having an average particle diameter of 100□) in 1600 ml of ethanol were added in portions by 20 g for 6 times, with the time interval of 20 minutes. After the same aging and washing steps as in Comparative example 1,558 g (98% yield) of a white solid powder were obtained.

By the same method as in Example 1, the particle shape of the resulted product was observed; the bulk density was measured; and the average particle diameter and particle size distribution index of particles and the content of large particles were determined. The results from the observation, measurement and determination were represented in Table 1 below.

TABLE 1

| | | | Average | Particle size | Content of large |
|---|---|---|---|---|---|
| | Particle | Bulk density | particle | distribution | particles |
| | shape | (g/cc) | size(D₅₀, □) | index | (>100□, weight %) |
| Example 1 | Sphere | 0.33 | 55 | 0.71 | 12.5 |
| Example 2 | Sphere | 0.32 | 55 | 0.75 | 2.8 |
| Example 3 | Sphere | 0.31 | 45 | 0.78 | 3.7 |
| Example 4 | Sphere | 0.32 | 40 | 0.77 | 6.2 |
| Example 5 | Sphere | 0.29 | 25 | 0.83 | 3.4 |
| Comp. | Sphere | 0.32 | 45 | 1.21 | 26.0 |
| example 1 | | | | | |
| Comp. | Sphere | 0.31 | 30 | 1.15 | 23.7 |
| example 2 | | | | | |

### INDUSTRIAL APPLICABILITY

As seen from Table 1, according to the present invention, it is possible to obtain a support for olefin polymerization catalyst satisfying the particle characteristics required to slurry polymerization, bulk polymerization, gas-phase polymerization and the like, owing to the spherical particle shape having even surface and the uniform p article size distribution of the resulted particles, and the minimized content of large particles having non-spherical shape and 100□ or more of particle diameter.

1. A method of preparation of spherical support for olefin polymerization catalyst, wherein a mixture of metal magnesium and alcohol is continuously introduced into a reactor containing a mixture comprising halogen compound and alcohol, and then the magnesium is reacted with the alcohol in the presence of the mixture comprising halogen compound and alcohol to produce dialkoxy-magnesium support.

2. The method according to claim 1, wherein the mixture comprising halogen compound and alcohol further comprises dialkoxymagnesium.

3. The method according to claim 1, wherein the total amount of alcohol used is 5-50 parts by weight per 1 part by weight of metal magnesium; the amount of the alcohol in the mixture comprising halogen compound and alcohol is 2-20 parts by weight per 100 parts by weight of the total amount of alcohol used; the amount of the halogen compound is 0.001-0.2 parts by weight per 1 part by weight of metal magnesium; and the amount of the dialkoxymagnesium optionally present in the mixture comprising halogen compound and alcohol is 0.05-0.5 parts by weight per 1 part by weight of the alcohol in the mixture comprising halogen compound and alcohol.

4. The method according to claim 1, wherein the alcohol is one or more of alcohols selected from the group consisting of aliphatic alcohols and aromatic alcohols, being used alone or as a mixture.

5. The method according to claim 1, wherein the halogen compound is halogen molecule, alkyl halide compound, acyl halide compound, aluminum halide compound, silicon halide compound, or metal halide compound.

6. The method according to claim 2, wherein the dialkoxymagnesium present in the mixture comprising halogen compound and alcohol has a form of spherical particle having 1.5 or less of particle size distribution and 10-100 μm of average particle diameter.

7. The method according to claim 1, wherein the metal magnesium has an average particle size of 10-300 μm.

8. The method according to claim 2, wherein the total amount of alcohol used is 5-50 parts by weight per 1 part by weight of metal magnesium; the amount of the alcohol in the mixture comprising halogen compound and alcohol is 2-20 parts by weight per 100 parts by weight of the total amount of alcohol used; the amount of the halogen compound is 0.001-0.2 parts by weight per 1 part by weight of metal magnesium; and the amount of the dialkoxymagnesium optionally present in the mixture comprising halogen compound and alcohol is 0.05-0.5 parts by weight per 1 part by weight of the alcohol in the mixture comprising halogen compound and alcohol.

9. The method according to claim 2, wherein the alcohol is one or more of alcohols selected from the group consisting of aliphatic alcohols and aromatic alcohols, being used alone or as a mixture.

10. The method according to claim 2, wherein the halogen compound is halogen molecule, alkyl halide compound, acyl halide compound, aluminum halide compound, silicon halide compound, or metal halide compound.

11. The method according to claim 2, wherein the metal magnesium has an average particle size of 10-300 μm.
